(19) United States
(12) Patent Application Publication
(10) Pub. No.: US 2026/0044469 A1
(43) Pub. Date: Feb. 12, 2026

(54) HYBRID CXL SWITCH FABRIC APPARATUS AND HYBRID CXL SWITCH APPARATUS

(71) Applicant: ELECTRONICS AND TELECOMMUNICATIONS RESEARCH INSTITUTE, Daejeon (KR)

(72) Inventor: Dae-Ub KIM, Daejeon (KR)

(73) Assignee: ELECTRONICS AND TELECOMMUNICATIONS RESEARCH INSTITUTE, Daejeon (KR)

(21) Appl. No.: 19/237,557

(22) Filed: Jun. 13, 2025

(30) Foreign Application Priority Data
Aug. 9, 2024 (KR) 10-2024-0106754

(51) Int. Cl. G06F 13/42; G06F 13/40

(52) U.S. Cl. CPC G06F 13/4221; G06F 13/4022; G06F 2213/0026

(57) ABSTRACT

Disclosed herein is a hybrid Compute Express Link (CXL) switch fabric apparatus. The hybrid CXL switch fabric apparatus, which connects two or more computing resources through Compute Express Link (CXL), may include one or more leaf switches via which a connection path between the physical port of the computing resource and a spine switch is bound through at least one internal bridge; and the spine switch for connecting the physical ports of the leaf switches.

### CROSS REFERENCE TO RELATED APPLICATION

This application claims the benefit of Korean Patent Application No. 10-2024-0106754, filed Aug. 9, 2024, which is hereby incorporated by reference in its entirety into this application.

### BACKGROUND OF THE INVENTION

### 1. Technical Field

The disclosed embodiment relates to switch technology for connecting computing resources.

### 2. Description of the Related Art

To enable data centers to continuously accommodate various services related to artificial intelligence, autonomous driving, robots, healthcare, virtual/augmented reality, and home networks, current computing resources include a host block having a central processing unit (CPU), which performs data processing and computing depending on computing and applications, peripheral devices of the host block, such as various types of accelerators (GPUs, NPUs, TPUs, etc.), which perform high-speed processing of specific data and accelerate and perform trainings, and memory, including DRAM, SRAM cache memory, and the like used by the processing units of the CPU and the accelerators to load data during the computing and data-processing processes, and computing and data processing are performed using these computing resources. In a cloud form in which various types of processing units collaborate, collaboration between a host CPU and heterogeneous processing units becomes important.

Currently, in order to enable a host to deliver processing data to memory attached to various processing units for interoperation therewith, the cores of the processing units, including the host, are required to access unattached memory and perform exchange of disaggregated coherency information or data in order to maintain coherency, and when multiple processing units, such as a host, accelerators, and the like, interoperate to perform computing and data processing, computing resource interconnections, such as a Compute Express Link (CXL) interface, are used to allow the processing units to directly access memory attached to the processing units participating in the interoperation.

Meanwhile, as processing performance and efficiency of a cloud in a data center become important, extensive data processing and computation are required. As a result, computer architectures and scalable systems that are suitable for the interaction and data volume between an increasing number of heterogeneous processing units are required.

CXL protocols and CXL switches provide a method that enables each processing unit to establish connection with memory attached to a processing unit of another board, to interoperate, and to maintain coherency, but the distance allowing interaction between the boards is very short (several centimeters) due to the electrical bus signal line connecting the boards and the high bandwidth. Accordingly, there is a limit to the number of connection links or connection ports.

Also, the electrical physical layers of PCIe and Flex-Bus of CXL establish a link through electrical connection, and this requires a complex link training and negotiation process. Therefore, when the negotiation is not smooth, repeated resets may occur.

### SUMMARY OF THE INVENTION

An object of the disclosed embodiment is to overcome the distance limitations attributable to the use of existing electrical-connection-based switches when expanding a cloud data center.

Another object of the disclosed embodiment is to enable simple data transmission and reception through a simple negotiation process or without a negotiation process when link connection and signal exchange are performed at a physical layer.

A hybrid Compute Express Link (CXL) switch fabric apparatus according to an embodiment may connect two or more computing resources through CXL and may include one or more leaf switches via which a connection path between the physical port of the computing resource and a spine switch is bound through at least one internal bridge and the spine switch for connecting the physical ports of the leaf switches.

Here, the physical ports of the leaf switches and the physical port of the spine switch may be managed by a fabric management unit, and the fabric management unit may manage the physical port of the leaf switch connected with the physical port of the computing resource as a switch edge port and manage a physical port connected between the spine switch and the leaf switch as a switch connection port.

Here, the leaf switch may include at least one virtual CXL switch (VCS) connected with the switch edge port and a physical bridge for connecting the switch edge port or the virtual CXL switch with the switch connection port.

Here, when the switch edge port is a port connected with a host, the switch edge port may be bound through the virtual CXL switch and the physical bridge.

Here, when the switch edge port is a port connected with a CXL device, the switch edge port may be bound through the physical bridge of the leaf switch.

Here, the spine switch may be an optical switch, and the leaf switch may be connected with the optical switch through an optic physical port.

Here, the physical bridge may be a hybrid optical bridge for connecting a Flex-Bus or PCIe physical layer with an optic physical layer (Optic PHY, OPHY).

Here, the physical bridge may be a hybrid electrical bridge for connecting Flex-Bus or PCIe physical layers between computing resources disaggregated from each other.

Here, the fabric management unit may further include an optical fabric management unit for managing optical connection between the optical switch and the leaf switch.

Here, when the hybrid optical bridge is a root-side bridge connected with a host through the virtual CXL switch, a reference clock may be terminated and at least one of a reset signal, a present detect signal, a link reactivation signal, or a power and management signal, or a combination thereof may be terminated or adaptively managed.

Here, when the hybrid optical bridge is a device-side bridge connected with a CXL device, a reference clock may be regenerated and at least one of a reset signal, a present detect signal, a link reactivation signal, or a power and management signal, or a combination thereof may be generated or adaptively managed.

A hybrid Compute Express Link (CXL) switch apparatus according to an embodiment may connect two or more computing resources through CXL, and a connection path between physical ports of the computing resources or optical switch ports may be bound through at least one internal bridge.

Here, a switch physical port connected with the physical port of the computing resource may be managed as a switch edge port, and a physical port of a switch connected with an optical switch may be managed as a switch connection port.

The hybrid CXL switch apparatus according to an embodiment may include at least one virtual CXL switch (VCS) connected with the switch edge port and a hybrid bridge for connecting the switch edge port or the virtual CXL switch with the switch connection port.

Here, the hybrid bridge may be a hybrid optical bridge for connecting a Flex-Bus or PCIe physical layer with an optic physical layer (Optic PHY, OPHY).

Here, the hybrid bridge may be a hybrid electrical bridge for connecting Flex-Bus or PCIe physical layers between computing resources disaggregated from each other.

Here, when the switch edge port is a port connected with a host, the switch edge port may be bound through the virtual CXL switch and the hybrid bridge.

Here, when the switch edge port is a port connected with a CXL device, the switch edge port may be bound through the hybrid bridge.

Here, when the hybrid bridge is a root-side bridge connected with a host through the virtual CXL switch, a reference clock may be terminated and at least one of a reset signal, a present detect signal, a link reactivation signal, or a power and management signal, or a combination thereof may be terminated or adaptively managed.

Here, when the hybrid bridge is a device-side bridge connected with a CXL device, a reference clock may be regenerated and at least one of a reset signal, a present detect signal, a link reactivation signal, or a power and management signal, or a combination thereof may be generated or adaptively managed.

### BRIEF DESCRIPTION OF THE DRAWINGS

The above and other objects, features, and advantages of the present disclosure will be more clearly understood from the following detailed description taken in conjunction with the accompanying drawings, in which:

FIGS. 1 to 3 are exemplary views of the structure of a Compute Express Link (CXL) switch;

FIGS. 4 to 6 are exemplary views of the structure of a hybrid Compute Express Link (CXL) switch fabric;

FIG. 7 is an exemplary view of the structure of a spine-leaf switching architecture according to an embodiment;

FIG. 8 is an exemplary view of the configuration of internal blocks of the hybrid CXL switch illustrated in FIG. 7; and

FIG. 9 is an exemplary view of the structure of a hybrid Compute Express Link (CXL) switch fabric according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

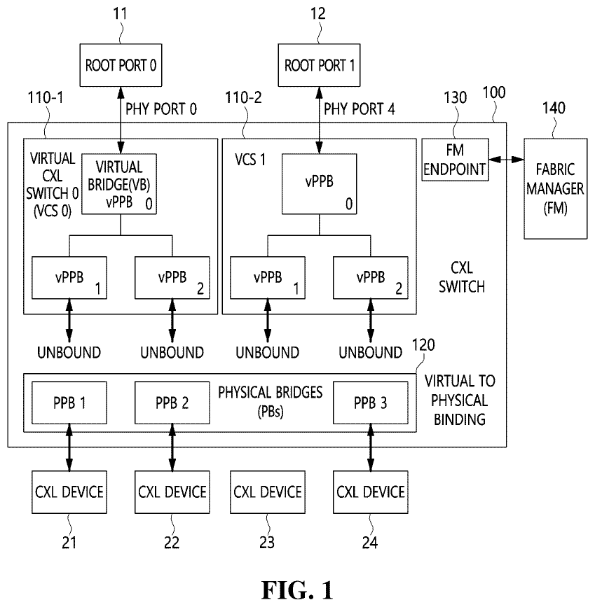

FIGS. 1 to 3 are exemplary views of the structure of a Compute Express Link (CXL) switch for connecting computing resources.

Referring to FIGS. 1 to 3, the CXL switch 100 may include one or more virtual CXL switches (VCSs) 110-1, 110-2, and 110-3 and physical bridges 120.

In each of the VCSs 110-1, 110-2, and 110-3, a single upstream port (USP) and at least one downstream port (DSP) may be provided.

Also, each of the VCSs 110-1, 110-2, and 110-3 may include a number of Virtual Bridges (VBs) equal to the number of ports.

Here, the virtual bridges (VBs) within each of the VCSs 110-1, 110-2, and 110-3 are classified into a USP-VB and a DSP-VB, and virtual bridge (VB) numbers that are managed may be sorted in the order of the VBs by using the connected USP or DSP, a bus number, a device number, and a function number.

That is, the VBs may include a virtual bridge (USP-VB) that can be bound to a single upstream port (USP) connected with each root port (RP) 11, 12, or 13 and one or more virtual bridges (DSP-VBs) that can be bound to downstream ports (DSPs).

Also, a physical bridge (PB) for each of the downstream ports (DSPs) is present, and each of the downstream ports (DSPs) of the CXL switch 100 is bound to the PB and DSP-VB corresponding thereto, whereby hierarchy for a switching path from the upstream port to the downstream port is formed.

Here, because the physical layer of the CXL switch 100 is implemented based on PCIe, each of the virtual bridges (VBs) included in each of the VCSs 110-1, 110-2, and 110-3 may be referred to as a virtual PCIe-to-PCIe bridge, that is, ‘vPPB’, and the physical bridge 120 may be referred to as a PCIe-to-PCIe bridge, or ‘PPB’, as illustrated in FIGS. 1 to 3.

Meanwhile, devices 21 to 24 connected with the downstream ports of the CXL switch may include highly scalable memory resources capable of being accessed by all hosts and all peer devices. Also, a CXL fabric capable of routing is configured with one or more interconnected fabric switches.

Also, the devices 21 to 24 connected with the downstream ports of the CXL switch may be classified into a Single Logical Devic (SLD) and a Multi-Logical Device (MLD).

Here, the DSP for the single logical device (SLD) is bound to the VB of a single VCS, thereby being connected with a single root port via a single USP.

On the other hand, the multi-logical device (MLD) is configured with multiple logical devices (LDs), and each of the multiple logical devices (LDs) is bound to multiple VCSs, thereby being connected with multiple root ports via multiple USPs.

A Fabric Manager (FM) 140 manages and coordinates the switch operation between the ports in the CXL switch 100 configured as described above.

That is, the FM 140 may establish connection with the CXL fabric and establish connection with selected endpoints through an out-of-band management network.

Also, the FM 140 may be in charge of initialization and setting. That is, the FM 140 initially binds a series of devices to the virtual layer of the host, thereby ultimately configuring a system.

After the system boots, the FM 140 may add or remove devices to or from the system by using fabric binding and unbinding operations.

That is, the FM 140 is in charge of and manages functions for port link control, error management log, and DSP port blocking. Also, it may manage memory-pooled devices for memory allocation change, LD activation, and the like.

A process in which switching is performed by setting and changing the binding between ports and multiple bridges or virtual bridges, which are configured in the CXL switch 100 as described above, will be described below.

Referring to FIG. 1, the DSP-VB of each of the VCSs 110-1 and 110-2 is initially unbound to the physical bridge (PB) 120 through a DSP, and may then be bound when a switching path is set.

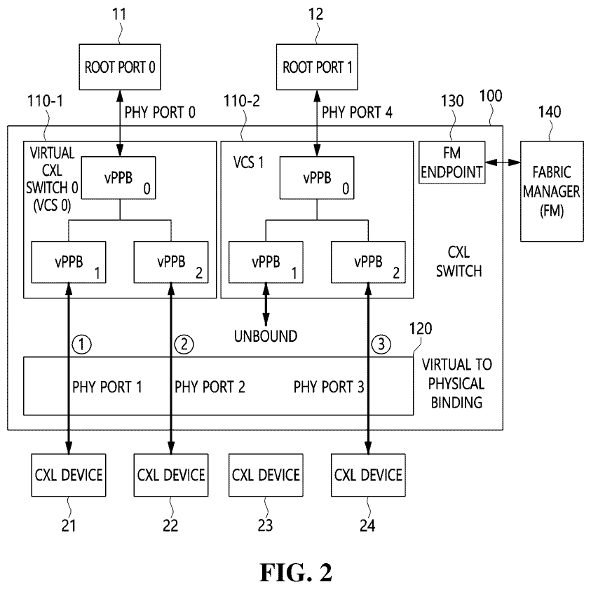

Next, referring to FIG. 2, a switch path may be mapped through the binding between the physical bridge 120 and the virtual bridges of the VCSs 110-1 and 110-2 based on the following three pieces of binding information \textcircled{1}, \textcircled{2}, and \textcircled{3}, including PHY_PORT #, which is a physical port number.
\textcircled{1} [PPB1, PHY_PORT1]
\textcircled{2} [PPB2, PHY_PORT2]
\textcircled{3} [PPB2, PHY_PORT3]

Based on the binding information, the binding between the virtual bridge and the physical bridge is established in the PB connected with the VB of the VCS 110-1 or 110-2, and the RP 11 or 12 of a host or root complex, a physical port number (PHY_Port #) corresponding thereto, the physical bridge (PB), and the physical port number (PHY_Port #) of the CXL device 21, 22, or 24 are connected through the CXL switch 100, whereby switching is performed.

The internal virtual bridges are then connected with each other, and the VB (DSP-VBa) of an arbitrary downstream port DSPa may be unbound through the switch process.

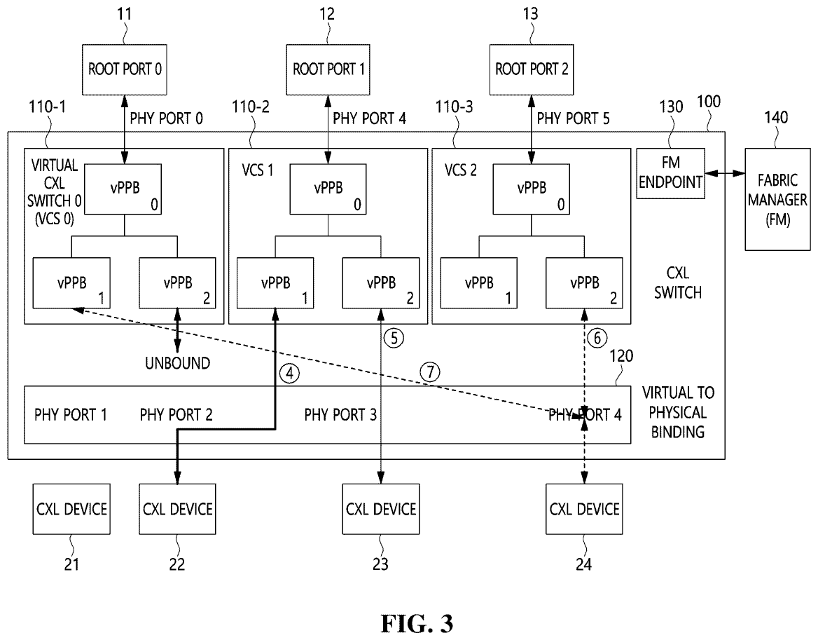

That is, FIG. 3 illustrates a switch state after the binding (\textcircled{2}) of VB2 of VCS0 illustrated in FIG. 2 is unbound.

When the binding of the vPPB is unbound as described above, the switch declares that the corresponding link is unavailable (link disable). Accordingly, the corresponding physical port is deactivated, and the physical bridge (Physical Bridge 2) and the virtual bridge are not bound.

That is, when the binding is unbound, the state is changed to a state in which a physical port is not present (no Presence Detect indication), which may result in a link-down state.

Then, vPPB1 of VCS1, which is in an unbound state in FIG. 2, may be bound to a physical bridge based on binding information \textcircled{4} [VCS1, vPPB1, PHY_PORT2] in FIG. 3, whereby a new switch path may be mapped through the binding between the physical bridge and the virtual bridge.

Meanwhile, multi-VCS may be implemented by building combinations of a plurality of individual VCS and an additional physical bridge. In other words, the physical port and the physical bridge 120 may be connected with one or more virtual bridges, i.e., two or three virtual bridges.

This may be implemented in such a way that the physical bridge connected with a single physical downstream port (DSP) is connected with multiple virtual bridges by performing a bridge function, and the different virtual bridges capable of being connected are connected with multiple different RPs 11 and 12 through different physical USPs, whereby a single DSP and multiple USPs may be pooled through a switch.

A switch connected to a CXL device port with MLD performs virtual-to-physical transition such that all transactions destined for a specific virtual switch and a specific virtual bridge are routed to an LD port set to a specific LD-ID.

The CXL device port with MLD provides a virtualized interface in order to enable multiple virtual bridges (vPPBs) to access the LDs through a shared physical interface.

The MLD port provides a virtualized interface in order to enable multiple vPPBs to access the LD through a shared physical interface.

That is, referring to FIG. 3, the CXL device 24 of physical port 4 (PHY PORT 4) is a device that supports MLD or pooling, and two or more root ports may be connected with a single CXL device 24 via a switch or fabric.

Here, using a 12-bit PID (SPID/DPID), CXL fabric expansion uniquely identifies up to 4096 edge ports by allowing topology of interconnected fabric switches.

However, in the general CXL switch structure illustrated in FIGS. 1 to 3, the links of the electrical physical layer of PCIe and Flex-Bus of CXL are connected through electrical connection, a complex link training and negotiation process has to be performed, and repeated resets may occur when the negotiation is not smooth, as described above.

However, in the case of optical connection, when a link is connected and signals are exchanged at a physical layer, it is possible to simply transmit and receive data through a simple negotiation process or without a negotiation process.

Therefore, in the disclosed embodiment, an optical switch, rather than the existing electrical-connection-based switch, is used to remove various complex physical layers and link management techniques for overcoming distance limitations and disadvantages of electrical buses and switches, whereby simple optic physical layer logic may be implemented. Also, distance scaling beyond the rack scale may be possible by providing flexible switching in future computing systems.

In the embodiment, the CXL switch fabric described above is for providing the connectivity scalability of computer resources using a CXL protocol, and the optical expansion of a CXL switch makes it possible to apply the CXL protocol at the rack scale and beyond by applying a fabric configured with an optical switch and a hybrid CXL switch using a hybrid optical bridge.

Through a pair of hybrid CXL switches and static connection and port change of an optical switch and optical cable, optical connection between a CXL device and a CXL host or a root complex may be provided.

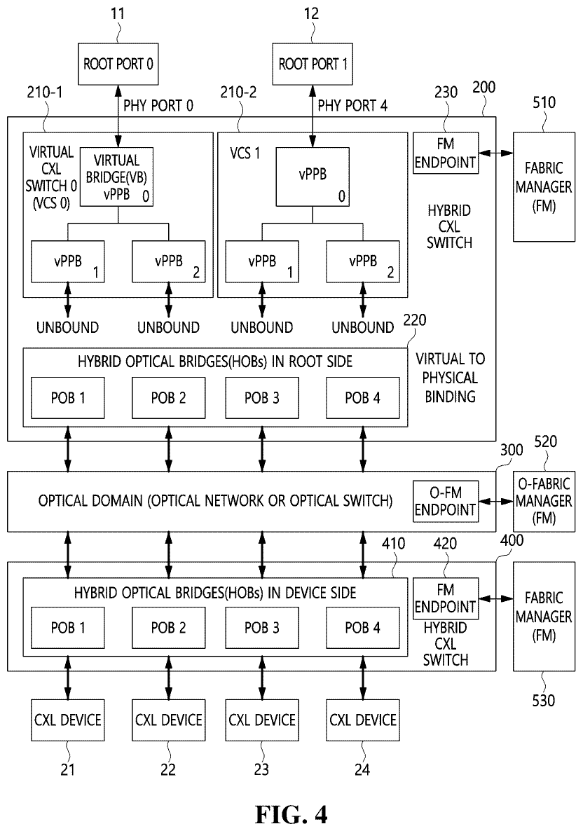

FIGS. 4 to 6 are exemplary views of the structure of a hybrid CXL switch fabric according to an embodiment.

Referring to FIG. 4, the hybrid CXL switch fabric according to an embodiment may include hybrid CXL switches 200 and 400 and an optical switch 300.

The CXL switches 200 and 400 may include at least one of one or more Virtual CXL switches (VCSs) 210-1 and 210-2, or physical bridges 220 and 410, or a combination thereof.

In each of the VCSs 210-1 and 210-2, an interface to be bound to a single upstream port (USP) and an interface to be bound to one or more downstream ports (DSPs) may be provided.

Also, each of the VCSs 210-1 and 210-2 may include a number of Virtual Bridges (VBs) equal to the number of ports.

Here, the virtual bridges (VBs) in the VCSs 210-1 and 210-2 may be classified into a USP-VB and a DSP-VB, and virtual bridge (VB) numbers that are managed may be sorted in the order of the VBs by using the connected USP or DSP, a bus number, a device number, and a function number.

That is, the virtual bridges may include a virtual bridge (USP-VB) that can be bound to a single upstream port (USP) connected with each of root ports (RPs) 11 and 12, and one or more virtual bridges (DSP-VB) that can be bound to downstream ports (DSPs).

Also, a physical bridge (PB) for each of the downstream ports (DSPs) is present, and each of the downstream ports (DSPs) of the hybrid CXL switches 200 and 400 is bound to the PB and DSP-VB corresponding thereto, whereby hierarchy for a switching path from the upstream port to the downstream port is formed.

Here, the portion related to the downstream ports (DSPs) of the hybrid CXL switches 200 and 400 according to an embodiment is changed, and it may be an optical switch for transmitting and receiving optical signals to and from an optical transceiver using an optical domain for connection with an optical switch or optical network 300 for extending the CXL device transmission distance from the DSP.

Also, unlike the bridge of the Flex-Bus used as the physical layer of CXL or the PCIe-to-PCIe bridge (PPB) between PCIe physical layers, the physical bridges 220 and 410 of the hybrid CXL switches 200 and 400 may be implemented as Hybrid Optical Bridges (HOBs) for providing a PCIe-to-Optic Bridge (POB) function between PCIe and an optic physical layer (Optic PHY (OPHY)).

Here, unlike PCIe physical layer transmission used by CXL, optical transmission through the POBs 220 and 410 requires clock recovery to terminate and regenerate a reference clock due to clock domain changes while passing through an optical domain.

Accordingly, in the case of a reset signal, a present detect signal, and a link reactivation signal on the POBs 220 and 410, the corresponding Flex-Bus physical layer signal or PCIe physical layer signal may be generated, terminated, or adaptively managed through fabric managers 510 and 530 or fabric manager endpoints 230 and 420, and the binding connection of the physical bridges 220 and 410 may be managed.

Also, in the case of power and other management signals on the POBs 220 and 410, the corresponding Flex-Bus physical layer signal or PCIe physical layer signal may be generated, terminated, or adaptively managed through the fabric managers 510, 520, and 530 or the fabric manager endpoints 230, 310, and 420, and the binding connection of the physical bridge 220 and 410 may be managed.

Here, the POB 220 may perform a root-side function, and the POB 410 may perform a device-side function.

In an embodiment, among the two hybrid CXL switches 200 and 400 illustrated in FIG. 4, the hybrid CXL switch 200 may be a basic form. On the device side, operation may be performed based on a physical bridge, without using the functions of the VCSs 210-1 and 210-2, so the hybrid CXL switch 400 from which a VCS is omitted is illustrated in FIG. 4 in order to help understanding. However, the VCSs 210-1 and 210-2 included in the hybrid CXL switch 200 may also be configured in the hybrid CXL switch 400.

The root-side POB (RS-POB) 220 is used for the USP through which a Flex-Bus or PCIe port is connected with the root port of a host or root complex, and each vPPB of a VCS is bound to the POB such that CXL switching is extended to the optical region through an optical DSP.

The PCIe portion of each RS-POB 220 is connected with the vPPB and the PCIe physical layer or the physical layer of CXL.

Each RS-POB 220 performs a bridging function for connection between the CXL Flex-Bus, which is the physical layer of the electrical interface of the existing CXL, and the optic physical layer according to an embodiment.

The CXL Flex-Bus or PCIe physical layer is appropriately mapped to the optic physical layer, whereby transmission/reception using signaling signals specified in each physical layer is possible. In order to employ the existing PCIe packet formats without change, a protocol identifier (ID) may be selectively recognized and used.

Variable-length flits are optionally provided to prevent roll-over that may occur in CXL, PCIe physical layer signaling signals are mapped to appropriate optic physical layer signaling signals, and a start frame boundary and an end frame boundary for a variable length are distinguished, whereby variable-length frames may be transmitted and received at the optic physical layer.

In the RS-POB 220, in connection with a CXL Flex-Bus or PCIe port, a reference clock is terminated, a reset signal, a present detect signal, and a link reactivation signal are terminated or adaptively managed, and power and other management signals are terminated or adaptively managed.

The device-side POB (DS-POB) 410 is configured with a DSP through which the port of Flex-Bus or PCIe, which is the physical layer of CXL, is connected with a CXL device for a signal received from the optical region, and the signal input to multiple optical ports may be bound to one POB and a DSP physical port.

In the DS-POB 410, in connection with a CXL Flex-Bus or PCIe port, a reference clock is regenerated, a reset signal, a present detect signal, and a link reactivation signal are generated or adaptively managed, and power and other management signals are also generated or adaptively managed.

The PCIe portion of each DS-POB 410 is connected with the vPPB and the PCIe physical layer or the physical layer of CXL.

Each DS-POB 410 performs a bridging function for connection between the optic physical layer applied to an embodiment and the CXL Flex-Bus, which is the physical layer of the electrical interface of the existing CXL, or the PCIe physical layer. The CXL Flex-Bus or PCIe physical layer is appropriately mapped to the optic physical layer, whereby transmission/reception using signaling signals specified in each physical layer is possible.

The RS-POB 220 and the DS-POB 410 are configured as a pair, and the DS-POB 410 performs the function of returning the adaptation from the CXL Flex-Bus or PCIe physical layer to the optic physical layer, which was performed in the RS-POB 220, to adaptation from the optic physical layer to the CXL Flex-Bus or PCIe physical layer.

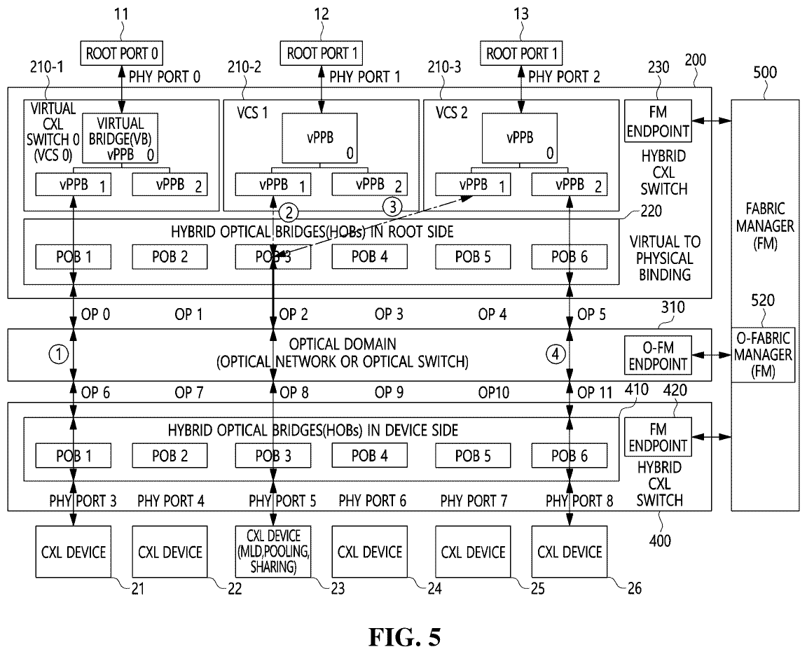

FIG. 5 illustrates that, using the RS-POB 220 and DS-POB 410 within the hybrid switches and the optical switch 300, the root port of the root complex is connected with the CXL physical port of the CXL device through CXL.

The CXL device 23 connected to physical port 5 (PHY PORT 5) is a CXL device that supports MLD, pooling or sharing, and multiple root complexes or multiple root ports may access the corresponding device.

In FIG. 5, binding information may be configured to include an optical port (OP), a DS-POB, and a RS-POB, and the following four binding paths may be managed through the binding information.
\textcircled{1} [PPB1, RS-POB1, OP0(RS), OP6(DS), DS-POB1, PHY_PORT3]
\textcircled{2} [PPB1, RS-POB3, OP2(RS), OP8(DS), DS-POB3, PHY_PORT5]
\textcircled{3} [PPB1, RS-POB3, OP2(RS), OP8(DS), DS-POB3, PHY_PORT5]
\textcircled{4} [PPB2, RS-POB6, OP5(RS), OP11(DS), DS-POB6, PHY_PORT8]

As shown in the above binding information \textcircled{2} and \textcircled{3}, it can be seen that access by two different root ports 12 and 13 is made through the RS-POB3 bridge connected with different VCSs (VCS1 and VCS2).

In FIG. 5, the binding information and multi-device access on the bridge are managed by a Fabric Manager (FM) 500, and the FM 500 may manage a connection path from the root port of the root complex to the CXL device and a band and may establish a connection to a selected end point through a management network.

Referring to FIG. 5, the optical fabric manager (Optical FM (O-FM)) 520 controls the optical path switching between the optical switch and the optical ports (OPs).

Here, the optical fabric manager (Optical FM (O-FM)) 520 may be included in the FM 500 as a part thereof, or the FM 500 of the hybrid CXL switches 200 and 400 manages the functions of the O-FM 520 in an integrated manner and manages binding and switching of the optical switch, the hybrid CXL switch 200 of the root side, and the hybrid CXL switch 400 of the device side in an integrated manner.

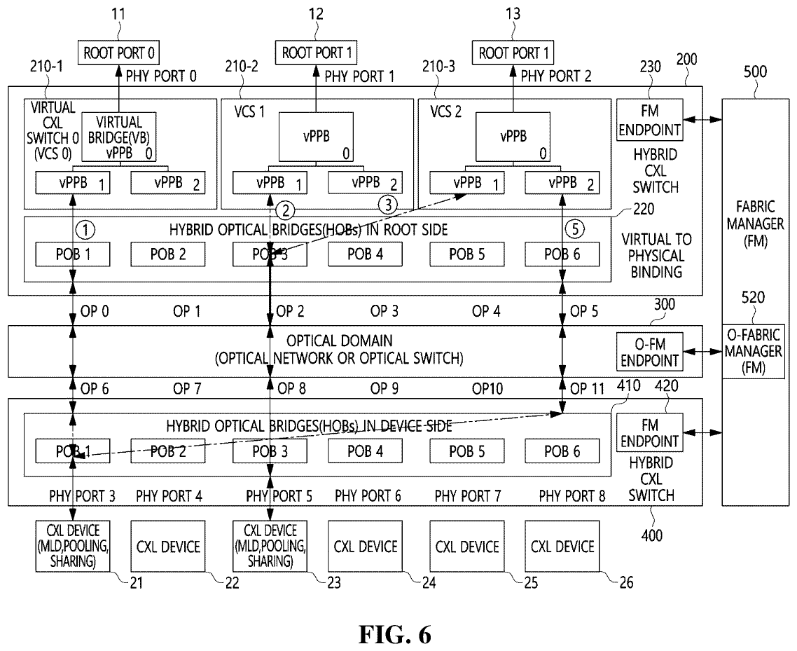

Referring to FIG. 6, the CXL devices 21 and 23 connected to physical port 3 (PHY PORT 3) and physical port 5 (PHY PORT 5) are CXL devices that support MLD, pooling or sharing, and may be accessed by multiple root complexes or multiple root ports.

Accordingly, referring to FIG. 6, the following four binding paths may be managed as binding information.
\textcircled{1} [PPB1, RS-POB1, OP0(RS), OP6(DS), DS-POB1, PHY_PORT3],
\textcircled{2} [PPB1, RS-POB3, OP2(RS), OP8(DS), DS-POB3, PHY_PORT5],
\textcircled{3} [PPB1, RS-POB3, OP2(RS), OP8(DS), DS-POB3, PHY_PORT5],
\textcircled{4} [PPB2, RS-POB6, OP5(RS), OP11(DS), DS-POB1. PHY_PORT3]

In the above binding information, unlike FIG. 5, the RS-POB1 and RS-POB6 connected with different VCSs (VCS0 and VCS2) enable multi-device access from two different root ports to the CXL device 21 connected to physical port 3 (PHY PORT 3) through the DS-POB1.

As described above, the hybrid switch using the DS-POB 410, the RS-POB 220, and the optical switch 300 increases scalability, compared to conventional CXL switches, through multiple access management on the RS-POB 220, switching of the optical switch, and multi-access management on the DS-POB 410.

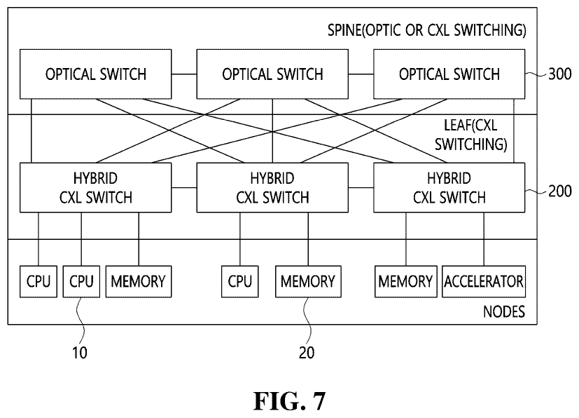

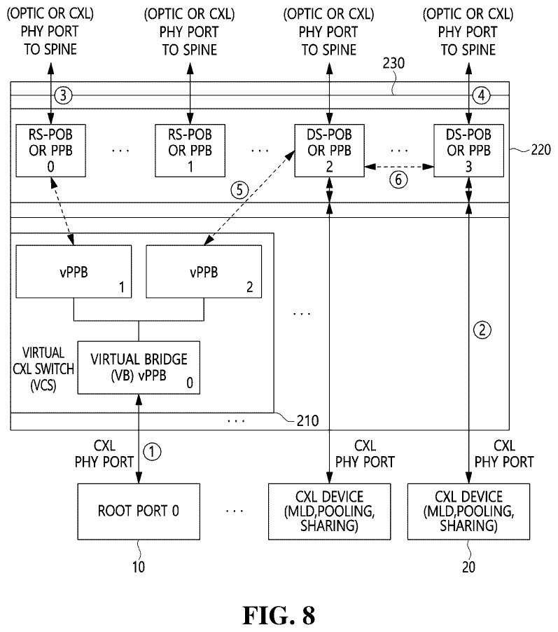

FIG. 7 is an exemplary view of a spine-leaf switching architecture structure according to an embodiment, and FIG. 8 is an exemplary view of the configuration of internal blocks of the hybrid CXL switch illustrated in FIG. 7.

Referring to FIG. 7, the hybrid CXL switch 200 may be connected with the root ports of multiple root complexes or multiple CXL devices, and the connected port may comprise multiple ports.

The spine-leaf switching architecture illustrated in FIG. 7 shows an example in which a host of CXL, a root complex, or nodes, such as a CPU, a GPU, an accelerator, memory, etc., which can be CXL devices, are connected through switches 200 and 300.

In FIG. 7, the optical switch 300 may be used as a spine switch. Also, at least one hybrid CXL switch 200 may be used as a leaf switch.

First, nodes 10 and 20, such as a CPU, a GPU, an accelerator, and memory, are connected to the leaf switch 200.

In the leaf switch 200, the CXL ports to which the nodes, such as a CPU, a GPU, an accelerator, and memory, are connected may be switch edge ports connected via a Flex-Bus or PCIe physical layer.

The connection port between the leaf switch 200 and the spine switch 300 may be a switch connection port.

The switch connection port does not need to be bound to the root port connected with the host or root complex.

Although it is possible to distinguish between the physical port for connection with the root port and the physical port for connection with the device and to form the existing CXL switch structure as multiple layers using a VCS such that the spine and the leaf have the same structure, binding and bridging functions between the physical ports may be performed through connection and binding of physical bridges (a PB or a PPB of CXL) without a VCS.

Particularly, connection between accelerator devices or memory devices, other than connection with the root port of the host, may be established through connection from a DSP to a DSP, as described above, and it may be configured by performing the binding and bridging functions between the physical ports through the connection and binding of the physical bridges (a PB or a PPB of CXL).

When it is connected with nodes (a host, a CPU, a GPU, and an accelerator) that have a root port, the switch edge port may be bound to the root port and may have a form of physical port that is bound through a VCS.

If it is not bound to a root port, that is, it is connection between devices, such as connection between accelerator devices or connection between memory devices, binding and bridging functions between physical ports may be performed through a physical bridge (a PB or a PPB of CXL, a POB of a hybrid switch).

The spine switch 300 is configured with only switch connection ports, and the leaf switch 200 includes a switch connection port and a switch edge port as physical ports.

Meanwhile, when an optical switch is used as the spine switch 300, the switch edge port and the switch connection port may have clearly different functions in the hybrid CXL switch.

The spine switch, which is an optical switch, is connected between optical switch connection ports through a change in the path of the physical optical switch.

The hybrid switch is configured such that an RS-POB and a DS-POB, which are physical bridges (a PB or a POBs of a hybrid CXL switch) of FIGS. 5 and 6, are present together in a single switch or in a pair, as illustrated in FIG. 8, whereby each switch port or each physical port may be connected with the root port of a root complex and may be connected with a CXL device.

The physical ports of the hybrid switch of FIG. 8 are classified into switch edge ports and switch connection ports.

Here, the switch edge port is classified into case \textcircled{1} in which it is connected with the root port 10 of a host or root complex and case \textcircled{2} in which it connected with a CXL device port 20.

That is, the physical port used as the switch edge port, among the physical ports of each hybrid switch, may be classified into a port bound to a VCS including a logical bridge, as in case \textcircled{1} in which it is connected with the root port 10 of the root complex, and a port that is bound to a DS-POB, which is a physical bridge, as in case \textcircled{2} in which it is connected to the CXL device port 20.

In case \textcircled{1} in which the switch edge port is connected with the root port 10 of the root complex, the port bound to the VCS including the logical bridge may be a physical port form that is bound to the root port and is bound through the VCS, among the switch edge ports.

In case \textcircled{2} in which the switch edge port is connected with the CXL device port 20, the port bound to the DS-POB, which is a physical bridge, is not in the form of being bound to the root port and is the port connected with the CXL device that is not used as a host or root complex, among the switch edge ports.

Meanwhile, the switch connection ports are classified into case \textcircled{3} for providing connection to the root port 10 of a host or root complex and the spine switch and case \textcircled{4} for providing connection with the CXL device port 20 in the spine switch.

Here, in case \textcircled{3} for providing connection to the root port 10 and the spine switch 220, the physical bridge is classified as an RS-POB, and the port bound to the RS-POB, which is a physical bridge, is the port connected to the optical switch used as a spine and is the port connected with the leaf switch and the spine optical switch in the hybrid switch structure.

In case \textcircled{4} for providing connection with the CXL device port 20 in the spine switch, the physical bridge is classified as a DS-POB, and the port bound to the DS-POB, which is a physical bridge, is the port connected with the optical switch used as a spine and is the port connected with the leaf switch and the spine optical switch in the hybrid switch structure.

Meanwhile, connection between the switch edge ports of the hybrid switch of FIG. 8 is possible, so the two switch edge ports may be connected with each other. Here, the connection between the two switch edge ports is classified into case \textcircled{5} in which connection is provided in such a way that the root port 10 of the host or root complex is bound to the CXL device port 20 through the DS-POB, which is a physical bridge, and case \textcircled{6} in which connection is provided in such a way that the CXL device ports 20 are bound through the DS-POB, which is a physical bridge therebetween.

Accordingly, in case \textcircled{2}, the CXL device port 20, which is connected with the DS-POB physical bridge as in case \textcircled{5} and case \textcircled{6}, may provide connection and switching in various cases.

However, when the spine switch is not an optical switch in FIG. 8, the RS-POB and DS-POB physical bridges may provide the same type of connection and switching as PPB physical bridges.

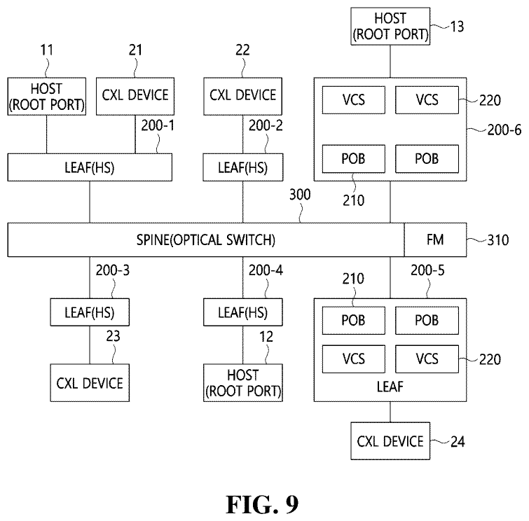

FIG. 9 is a schematic configuration diagram of a hybrid CXL switch fabric apparatus according to an embodiment.

Referring to FIG. 9, the hybrid CXL switch fabric apparatus according to an embodiment may connect two or more computing resources through Compute Express Link (CXL).

The hybrid CXL switch fabric apparatus may include one or more leaf switches 200-1 to 200-6 via which a connection path between a spine switch 300 and the physical ports of computing resources 11, 12, 13, 21, 22, 23, and 24 is bound through one or more internal bridges 210 and 220 and the spine bridges 300 for connecting the physical ports between the leaf switches 200-1 to 200-6.

Here, the computing resources may include hosts 11, 12, and 13, such as CPUs, and CXL devices 21, 22, 23, and 24, such as GPUs, accelerators, and memory.

Here, the leaf switches 200-1 to 200-6 and the spine switch 300 are managed by a fabric management unit 310, and the fabric management unit 310 may manage the physical ports of the leaf switches 200-1 to 200-6 connected with the physical ports of the computing resources as switch edge ports and manage the physical ports connected between the spine switch 300 and the leaf switches 200-1 to 200-6 as switch connection ports.

Here, each of the leaf switches 200-1 to 200-6 may include at least one virtual CXL switch (VCS) 220 connected with the switch edge port and a physical bridge 210 for connecting the switch edge port or the virtual CXL switch (VCS) 220 with the switch connection port.

Here, when the switch edge port is a port connected with a host, it may be bound through the virtual CXL switch 220 and physical bridge 210 of the leaf switches 200-1 to 200-6.

Here, when the switch edge port is not a port connected with a host, it is not bound to the Virtual CXL Switch (VCS) 220, and the physical bridge 210 may be bound directly to both the switch edge port and the switch connection port so as to provide switching or connection.

Here, when the switch edge port is a port connected with a CXL device, it may be bound through the physical bridge 210 of the leaf switches 200-1 to 200-6.

Here, the spine switch 300 is an optical switch, and the leaf switches 200-1 to 200-6 may be connected with the optical switch 300 through an optic physical port.

Here, the physical bridge 210 may be a hybrid bridge for connecting the switch edge port or the virtual CXL switch (VCS) with the switch connection port.

The physical bridge 210 may be a hybrid optical bridge for connecting the Flex-Bus or PCIe physical layer with the optic physical layer (Optic PHY (OPHY)), or the physical bridge 210 may be a hybrid electrical bridge for connecting the Flex-Bus or PCIe physical layers between computing resources disaggregated from each other.

Here, the fabric management unit 310 may further include an optical fabric management unit for managing the optical connection between the optical switch and the leaf switch.

Here, when the hybrid optical bridge 210 is a root-side bridge connected with the host via a virtual CXL switch, a reference clock is terminated and at least one of a reset signal, a present detect signal, a link reactivation signal, or a power and management signal, or a combination thereof may be terminated or adaptively managed.

Here, when the hybrid optical bridge 210 is a device-side bridge connected with the CXL device, a reference clock is regenerated and at least one of a reset signal, a present detect signal, a link reactivation signal, or a power and management signal, or a combination thereof may be generated or adaptively managed.

According to the disclosed embodiment, various complex physical layers and link management techniques for overcoming disadvantages of electrical buses and switches are eliminated by using a hybrid optical bridge and applying a hybrid CXL switch and an optical switch fabric, whereby simple optic physical layer logic may be realized. Also, distance scaling beyond the rack scale may be possible by providing flexible switching in future computing systems.

According to the disclosed embodiment, it is possible to stably implement a CXL switch fabric through functions and management characteristics of a port connected with a host of CXL or the root port of a root complex, a port connected with a CXL device, and a port connected between switches in the CXL switch fabric, and a CXL switch and a hybrid CXL switch that enable multi-access management through bridges may be provided.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A hybrid Compute Express Link (CXL) switch fabric apparatus for connecting two or more computing resources through CXL, comprising:
one or more leaf switches via which a connection path between a physical port of the computing resource and a spine switch is bound through at least one internal bridge; and
the spine switch for connecting physical ports of the leaf switches.

2. The hybrid CXL switch fabric apparatus of claim 1, wherein
the physical ports of the leaf switches and a physical port of the spine switch are managed by a fabric management unit, and
the fabric management unit manages the physical port of the leaf switch connected with the physical port of the computing resource as a switch edge port and manages a physical port connected between the spine switch and the leaf switch as a switch connection port.

3. The hybrid CXL switch fabric apparatus of claim 2, wherein the leaf switch includes at least one virtual CXL switch (VCS) connected with the switch edge port and a physical bridge for connecting the switch edge port or the virtual CXL switch with the switch connection port.

4. The hybrid CXL switch fabric apparatus of claim 3, wherein, when the switch edge port is a port connected with a host, the switch edge port is bound through the virtual CXL switch and the physical bridge.

5. The hybrid CXL switch fabric apparatus of claim 3, wherein, when the switch edge port is a port connected with a CXL device, the switch edge port is bound through the physical bridge of the leaf switch.

6. The hybrid CXL switch fabric apparatus of claim 3, wherein
the spine switch is an optical switch, and
the leaf switch is connected with the optical switch through an optic physical port.

7. The hybrid CXL switch fabric apparatus of claim 6, wherein the physical bridge is a hybrid optical bridge for connecting a Flex-Bus or PCIe physical layer with an optic physical layer (Optic PHY (OPHY)).

8. The hybrid CXL switch fabric apparatus of claim 6, wherein the physical bridge is a hybrid electrical bridge for connecting Flex-Bus or PCIe physical layers between computing resources disaggregated from each other.

9. The hybrid CXL switch fabric apparatus of claim 6, wherein the fabric management unit includes an optical fabric management unit for managing optical connection between the optical switch and the leaf switch.

10. The hybrid CXL switch fabric apparatus of claim 7, wherein, when the hybrid optical bridge is a root-side bridge connected with a host through the virtual CXL switch, a reference clock is terminated and at least one of a reset signal, a present detect signal, a link reactivation signal, or a power and management signal, or a combination thereof is terminated or adaptively managed.

11. The hybrid CXL switch fabric apparatus of claim 7, wherein, when the hybrid optical bridge is a device-side bridge connected with a CXL device, a reference clock is regenerated and at least one of a reset signal, a present detect signal, a link reactivation signal, or a power and management signal, or a combination thereof is generated or adaptively managed.

12. A hybrid Compute Express Link (CXL) switch apparatus for connecting two or more computing resources through CXL, comprising:
at least one internal bridge through which a connection path between physical ports of the computing resources or optical switch ports is bound.

13. The hybrid CXL switch apparatus of claim 12, wherein
a switch physical port connected with the physical port of the computing resource is managed as a switch edge port, and
a physical port of a switch connected with an optical switch is managed as a switch connection port.

14. The hybrid CXL switch apparatus of claim 13, further comprising:
at least one virtual CXL switch (VCS) connected with the switch edge port; and
a hybrid bridge for connecting the switch edge port or the virtual CXL switch with the switch connection port.

15. The hybrid CXL switch apparatus of claim 14, wherein the hybrid bridge is a hybrid optical bridge for connecting a Flex-Bus or PCIe physical layer with an optic physical layer (Optic PHY (OPHY)).

16. The hybrid CXL switch apparatus of claim 14, wherein the hybrid bridge is a hybrid electrical bridge for connecting Flex-Bus or PCIe physical layers between computing resources disaggregated from each other.

17. The hybrid CXL switch apparatus of claim 14, wherein, when the switch edge port is a port connected with a host, the switch edge port is bound through the virtual CXL switch and the hybrid bridge.

18. The hybrid CXL switch apparatus of claim 14, wherein, when the switch edge port is a port connected with a CXL device, the switch edge port is bound through the hybrid bridge.

19. The hybrid CXL switch apparatus of claim 14, wherein, when the hybrid bridge is a root-side bridge connected with a host through the virtual CXL switch, a reference clock is terminated and at least one of a reset signal, a present detect signal, a link reactivation signal, or a power and management signal, or a combination thereof is terminated or adaptively managed.

20. The hybrid CXL switch apparatus of claim 14, wherein, when the hybrid bridge is a device-side bridge connected with a CXL device, a reference clock is regenerated and at least one of a reset signal, a present detect signal, a link reactivation signal, or a power and management signal, or a combination thereof is generated or adaptively managed.
